(19) United States
(12) Patent Application Publication
(10) Pub. No.: US 2009/0248504 A1
(43) Pub. Date: Oct. 1, 2009

(54) MECHANISM FOR AGGREGATING CONSUMER REWARD DATA

(76) Inventors: Carol Thomas, Romana, CA (US); Michael Reed, San Diego, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/055,574

(22) Filed: Mar. 26, 2008

(51) Int. Cl. G06Q 30/00

(52) U.S. Cl. 705/14

(57) ABSTRACT

A method of aggregating consumer reward data. The consumer reward data is generated from a consumer visiting a website. The method includes receiving a request from a consumer to maintain consumer reward data in a data warehouse. Web reward token information is received from a website operator following a visit to the website by the consumer. A request to redeem consumer rewards for goods/services is generated.

### BACKGROUND

Reward programs provide a mechanism to incentivise consumers to purchase products from particular vendors.

Current reward programs are typically based on receiving reward coupons for purchasing products from multiple vendors. Families, civic organizations, schools and other groups then pool or combine their coupons to redeem them for merchandise.

Some internet based rewards programs are based on buying merchandise or services from individual vendors. Reward points are valid only for an individual merchant. Such prior techniques do not permit the pooling of reward points for groups.

### SUMMARY

Described below is a method of aggregating consumer reward data The consumer reward data is generated from a consumer visiting a website. The method includes receiving a request from a consumer to maintain consumer reward data in a data warehouse. Web reward token information is received from a website operator following a visit to the website by the consumer. A request to redeem consumer rewards for goods/services is generated

### BRIEF DESCRIPTION OF THE DRAWINGS

FIG. 1 shows an example system suitable for handling consumer reward data.

FIG. 2 shows an example user table.

FIG. 3 shows an example group table.

FIG. 4 shows a preferred form token table.

FIG. 5 shows an example product table.

FIG. 6 shows a preferred form user interface to permit a user to create a new identity.

FIG. 7 shows a preferred form joined group interface.

FIG. 8 shows a preferred form administration interface.

FIG. 9 shows a further administrator interface.

FIG. 10 shows a change administrator user interface.

FIG. 11 shows a preferred form user interface permitting groups to redeem goods.

### DETAILED DESCRIPTION

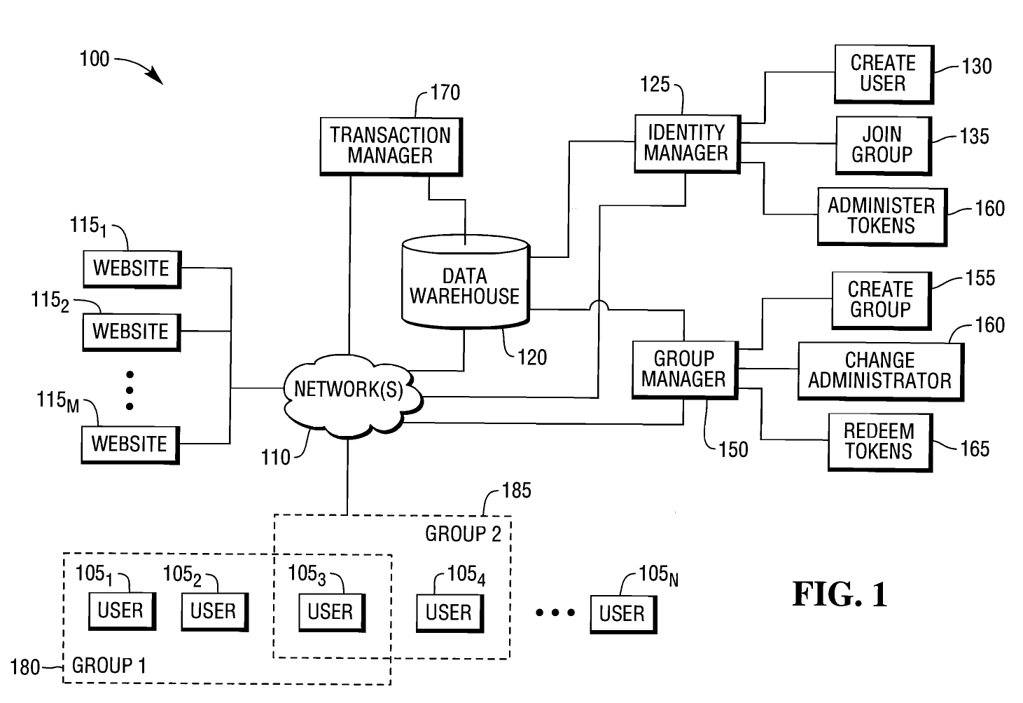

FIG. 1 shows an example system 100 suitable for consumer reward data in accordance with techniques described below. System 100 includes a plurality of users 105_{1 . . . N}. Each user 105 operates a networked computing device that is interfaced to one or more data networks 110. Using data networks 110 individual users 105 access one or more websites 115_{1 . . . M}. The techniques described below provide benefits to the user 105 for visiting or accessing a particular website 115.

The system includes a data warehouse 120. A suitable data warehouse is described below. Within the data warehouse 120 is maintained a plurality of data tables which are further described below. Individual users 105 access an identity manager component 125. The identity manager component 125 provides user interface screens to an individual user. These interface screens include the functionality to create user 130, join a group 135 and administer tokens 140.

System 100 includes a group manager component 150. Group manager component 150 provides further user interface screens to enable a group administrator to create a group 155, change administrator for an individual group 160 and redeem tokens 165.

System 100 further includes a transaction manager component 170 that stores details of tokens generated from the interaction of users 105 with websites 115.

Some of the users 105 are organized into individual groups. For example users 105₁, 105₂ and 105₃ are members of group 180. Users 105₃ and 105₄ are members of a further group 185. Examples of individual groups include family members, club members, school members and so on.

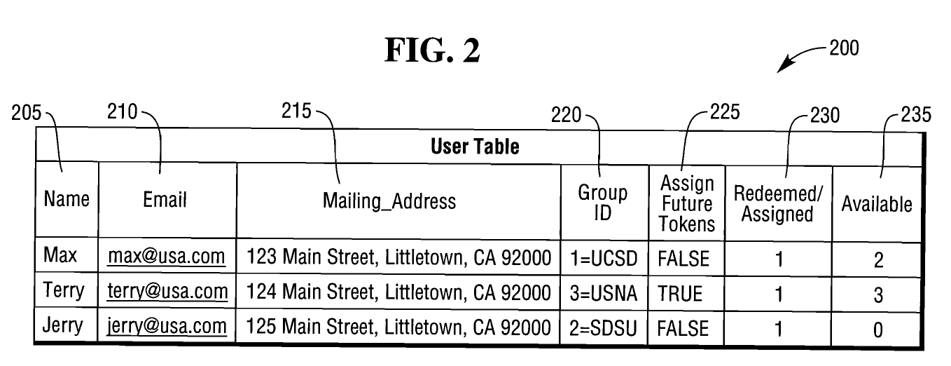

Individual user details are stored in a user table in data warehouse 120. An example user table is shown in FIG. 2. An example user table 200 is created using a create table command in SQL. An example command is set out below:

```
CREATE TABLE user (
    Name VARCHAR(20),
    Email VARCHAR(50), /*unique throughout system*/
    Mailing _address Address_UDT,
    Assign_future_tokens BOOLEAN /* TRUE if future tokens
    automatically assigned to group*/
    Group_id INTEGER, /* Group this user currently
    associated with */
    Redemmed INTEGER, /* Total token transactions
    redeemed */
    Available INTEGER /* Total token transactions
    available */
    );
```

A preferred form table 100 includes a user name 205 for example Max, Terry or Jerry. Each user has an email address 210 that is unique throughout system 100. Each user optionally includes a mailing address 215. Individual users include a group indentifier 220 indicating a group to which the user belongs. There is a Boolean value 225 associated with each user as to whether or not that user assigns future tokens to the group of which they are a member.

Table 200 also includes an integer value 230 representing the number of tokens redeemed or assigned/transferred to another group and the number of tokens 235 still available to that user.

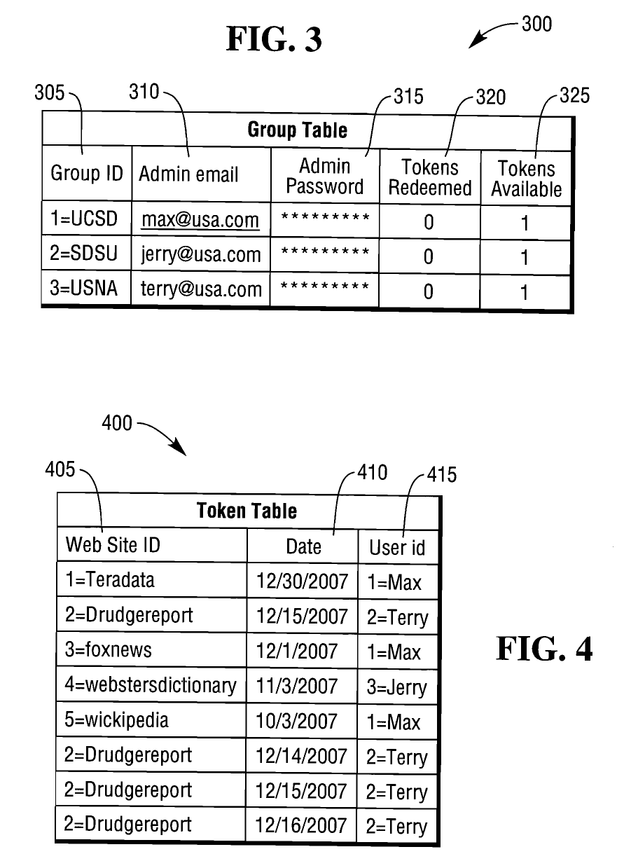

FIG. 3 shows an example group table 300 stored in data warehouse 120. The group table 300 includes a group name 305 for example UCSD, SDSU or USNA. Each group includes one user that is designated as an administrator of the group. The group table 300 includes admin email 310 identifying the current group administrator email and password 315. The group table optionally includes a redeemed value 320 representing the number of tokens already redeemed by this group and an available number 325 indicating the number of tokens currently available for redemption by the group.

Set out below is a preferred create table statement for the group table.

```
CREATE TABLE group (
    Group VARCHAR(30), /* participating group */
    Admin UDT_Admin, /* email identifying current group
    administer & password */
    Address UDT_Address, /* Mailing address where
    products will be sent */
    Redemmed INTEGER, /* # of tokens already redeemed by
    this group */
    Available INTEGER /* # of tokens currently available
    for redemption by this group */
```

FIG. 4 shows a preferred form token table 400. As users 105 interact with websites 115 the website operators associated with an individual website 115 transmit data to the data warehouse and transaction manager indicating the user who visited the website and the number of tokens generated from that visit. The preferred form token table includes a website identifier 405 representing the participating website that was visited, the date 410 the token was earned and a user ID 415 representing the user that earned the token.

A transaction_token table is generated by the following create table statement.

```
CREATE TABLE transaction_token (
      Web_site VARCHAR(30), /* Name of participating web
      site */
      Web_site_id INTEGER, /*unique throughout system per
      participating web site */
      Date DATE, /* Date the token was earned */
      User_id INTEGER /* registered user who earned this
      token */
      );
```

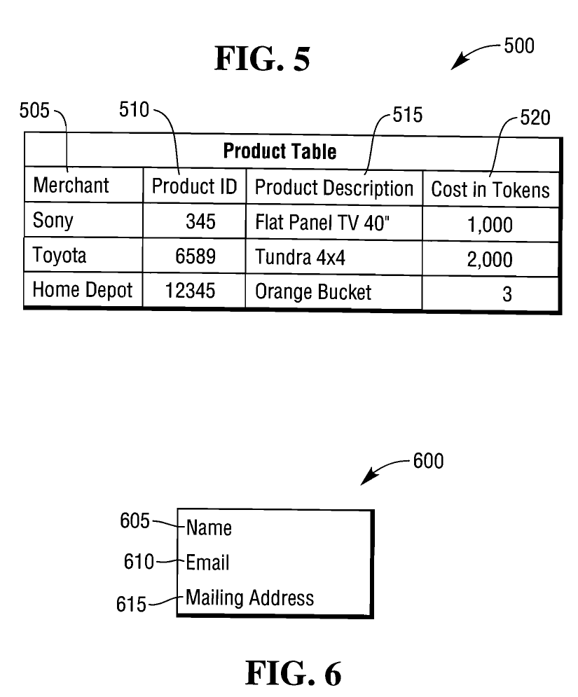

As described above it is envisaged that groups redeem consumer rewards in the form of tokens for products. Details of available products are stored as shown in FIG. 5 in a product table 500. The product table 500 includes a merchant name 505, a product identifier 510, a product description 515 and the cost or number of tokens required 520 to redeem the product.

The preferred form product table 500 is generated by the following create table statement.

```
CREATE TABLE product (
      Merchant VARCHAR(20),
      Product_id INTEGER,
      Description VARCHAR(20),
      Tokens INTEGER /* tokens required to redeem product
      */
```

In use a user signs up with the system using the create user interface 130. FIG. 6 illustrates a preferred form user interface 600 as presented to a user to enable the user to sign up to the system. The user enters for example names 605, email 610, and mailing address 615. By entering this data the user submits a request to maintain consumer reward data in the data warehouse.

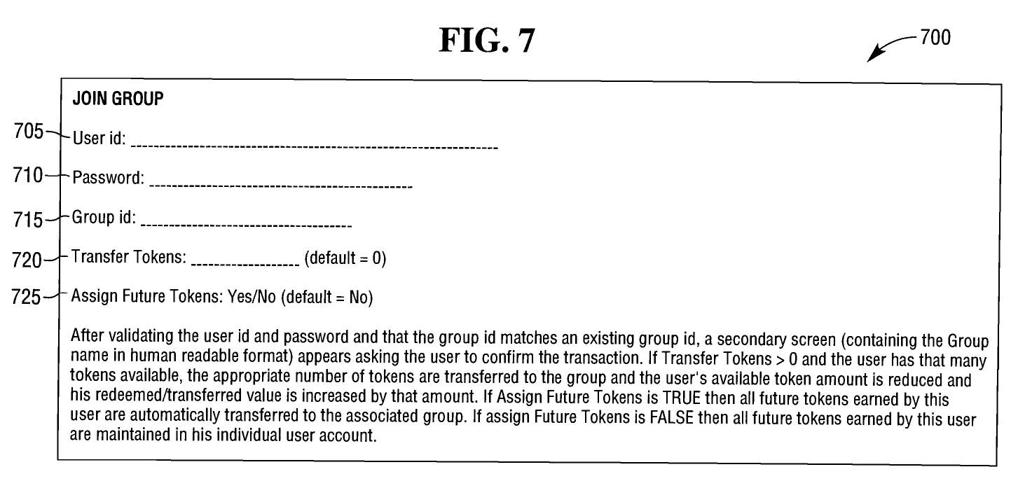

Once the user has registered with the system the user is able to join a group using the join group interface 135. FIG. 7 shows a preferred form join group interface 700. The user enters their user ID 705 and a password 710 together with the group 715 with which the user wishes to be associated. It is preferred that the group is selected from a list of available groups.

If the user joins a group the user is asked whether they wish to transfer 720 any tokens to this group. In one embodiment the user specifies a number of tokens greater than or equal to zero. If so the user is asked how many tokens to transfer. The user is also asked to specify whether the user wishes to assign 725 all future tokens to this group.

The system validates the user ID and password against the details stored in the data warehouse 120. The system further validates that the group identifier specified by the user matches an existing group identifier. Following validation a secondary screen containing the group name in human readable format is presented to the user. The secondary screen asks the user to confirm the transaction.

If the number of tokens to transfer is specified as a number greater than zero the system validates that the user has that many tokens available. If so, the appropriate number of tokens are transferred to the group. The users' available token amount is reduced and the redeemed or transferred value is increased by that amount.

If the user has set the Assign Future Tokens field 725 to true then all future tokens earned by this user are automatically transferred to the associated group. On the other hand if Assign Future Tokens is false then all future tokens earned by this user are maintained in an individual user account.

It is expected that a user access the join group interface to belong to as many groups as the user wishes. However it is expected that there will be restrictions on assigning future tokens. In one form a user may have this option set for only one group. In another form the user may be able to specify the assigned future tokens to more than one group. As the user generates tokens each group is allocated a share or proportion of the tokens if they have been nominated as a group to which future tokens are to be assigned.

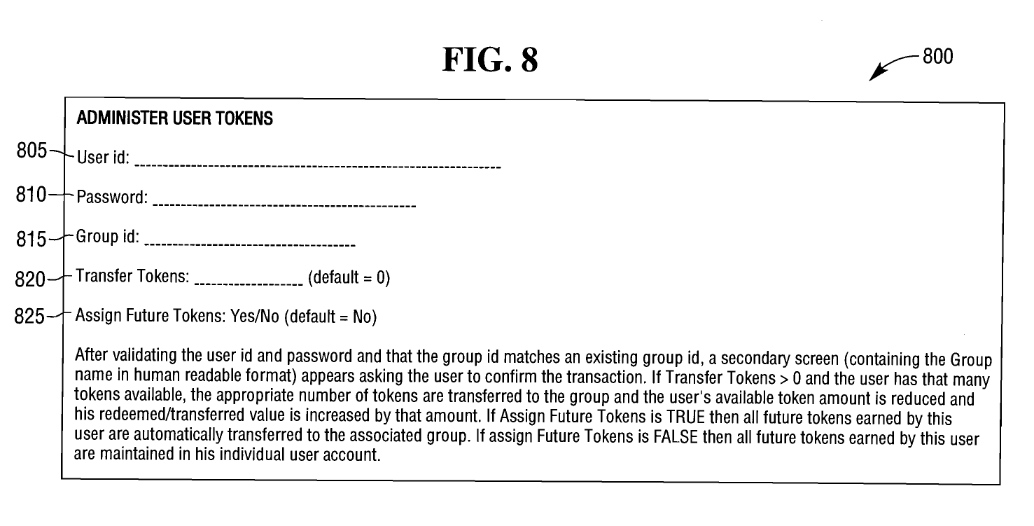

FIG. 8 shows a preferred form interface 800 to enable a user to administer user tokens. The user enters a user ID 805 and password 810. The user then enters a group identifier 815 in the same manner as that described above. The user specifies a group and enters details such as that described above for transferring tokens 820 to the nominated group or assigning future tokens 825 to the nominated group.

After validating the user ID and password the system validates that the group identifier matches an existing group identifier as described above.

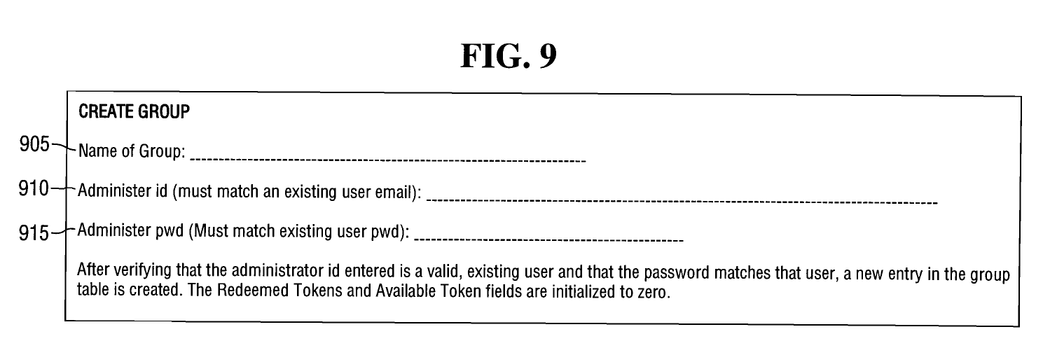

FIG. 9 shows a preferred form interface 900 presented to a group administrator by group manager component 150. Interface 900 permits a user to enter the name of a group 905, an administrator identifier 910 and administrator password 915.

After verifying that the administrator identifier is valid and that the existing user and password matches the current user, the system creates a new entry in the group table stored in data warehouse 120. When a group is created the redeemed tokens field and available tokens fields are initialized to zero.

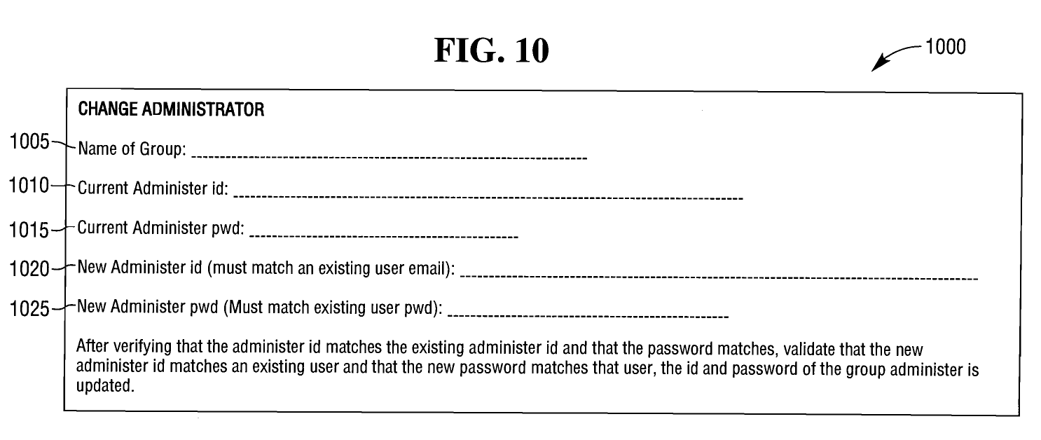

FIG. 10 shows a preferred form interface 1000 that permits an administrator to be changed. The user enters the name of the group 1005, a current administrator identifier 1010 and a current administrator password 1015.

The user interface permits a user to enter a new administrator identifier 120 and a new administrator password 1025.

The system verifies that the administrator identifier matches the existing administrator ID and password.

The system validates that the new administrator ID matches an existing user and that the new password matches that user. On validation the identifier and password of the group administrator is updated.

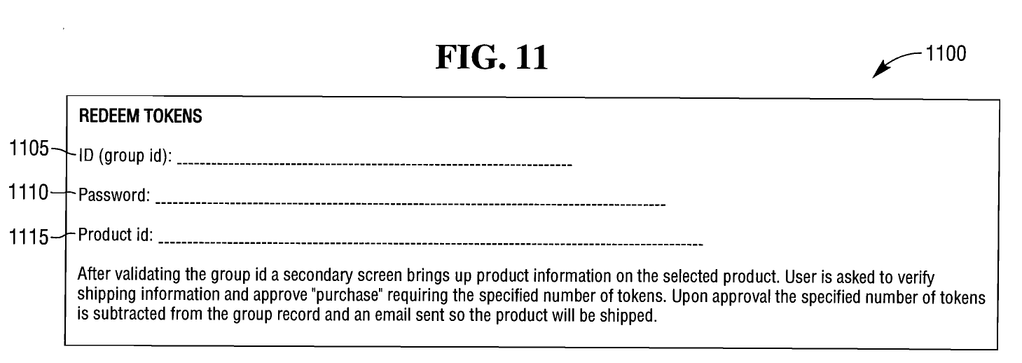

The system further permits a group manager component to redeem tokens through a redeemed tokens interface 165. A preferred form interface 1100 as shown in FIG. 11. The group administrator enters a group identifier 1105 and password 1110. The user also specifies a product identifier 1115. The product identifier uniquely details of products stored either in data warehouse 120 or on servers associated with websites 115. A product identifier uniquely identifies an individual product within system 100.

After validating a group identifier and password, a secondary screen brings up product information on the selected product. The user is asked to identify shipping information and approve purchase using the specified number of tokens. Upon approval the specified number of tokens is subtracted from the group record and an email sent on the product is then shipped.

Participants use reward tokens to redeem merchandise and/or services from multiple vendors. This merchandise is not just from those websites the participant has visited. Therefore creating greater incentive to visit participating websites.

Participants are able to create groups and to pool or combine their reward tokens. Therefore they are pooling their redemption power. This creates greater incentive for people to use participating websites.

Online redemption of reward token is simple, private, secure and of the convenience of the consumer.

Information about each consumer and participating groups can be data mined from the rewards that they select.

The text above describes one or more specific embodiments of a broader invention. The invention also is carried out in a variety of alternative embodiments and thus is not limited to those described here. Those other embodiments are also within the scope of the following claims.

We claim:

1. A method of aggregating consumer reward data, the consumer reward data generated from a consumer visiting a website, the method comprising:
receiving a request from a consumer to maintain consumer reward data in a data warehouse;
receiving web reward token information from a website operator following a visit to the website by the consumer; and
generating a request to redeem consumer rewards for goods/services.

2. The method of claim 1 wherein the request to maintain consumer reward data includes a request to create a group of consumers.

3. The method of claim 1 wherein the request to maintain consumer reward data includes a request to join an existing group of consumers.

4. The method of claim 3 wherein the group includes a consumer designated as a group administrator.

5. The method of claim 4 wherein the group administrator approves or declines requests from the consumer to join the existing group of consumers.

6. The method of claim 4 further comprising generating the request to redeem consumer rewards only at the request of the group administrator.

7. Computer readable media on which is stored computer executable instructions that when executed on a computing device cause the computing device to perform a method of aggregating consumer reward data, the consumer reward data generated from a consumer visiting a website, the method comprising:
receiving a request from a consumer to maintain consumer reward data in a data warehouse;
receiving web reward token information from a website operator following a visit to the website by the consumer; and
generating a request to redeem consumer rewards for goods/services.

8. Computer readable media as claimed in claim 7 wherein the request to maintain consumer reward data includes a request to create a group of consumers.

9. Computer readable media as claimed in claim 7 wherein the request to maintain consumer reward data includes a request to join an existing group of consumers.

10. Computer readable media as claimed in claim 9 wherein the group includes a consumer designated as a group administrator.

11. Computer readable media as claimed in claim 10 wherein the group administrator approves or declines requests from the consumer to join the existing group of consumers.

12. Computer readable media as claimed in claim 10 wherein the method further comprises generating the request to redeem consumer rewards only at the request of the group administrator.
